(19) United States
(12) Patent Application Publication
(10) Pub. No.: US 2005/0034716 A1
(43) Pub. Date: Feb. 17, 2005

(54) Portable compact cooking appliance

(76) Inventor: Lawrence Harbin, Alexandria, VA (US)

Correspondence Address: LAWRENCE HARBIN;MCINTYRE HARBIN & KING LLP, 500 9TH STREET, S.E., WASHINGTON, DC, 20003, US

(21) Appl. No.: 10/724,819

(22) Filed: Dec. 2, 2003

Related U.S. Application Data
(60) Provisional application No. 60/430,046, filed on Dec. 2, 2002.
(60) Provisional application No. 60/431,224, filed on Dec. 6, 2002.

(51) Int. Cl. A47J 37/00

(52) U.S. Cl. 126/25 R

(57) ABSTRACT

A compact cooking appliance, such a portable grill or oven, has a cooking region, a firebox disposed laterally rather than beneath the cooking region to generate heated gases, a heat exchanger disposed in heat-exchanging relationship with the heated gases, a blower or fan that circulates heated air within the cooking region, and a thermoelectric converter that derives power from the heat produced to power the blower. Instead of a heat exchanger, fuel gases may be directly vented into the cooking region. A controller may control the temperature and/or other operating conditions of the appliance. A method of cooking comprises providing a cooking region, generating heated gases, circulating heated air between a heat exchanger and the cooking region, thermoelectrically converting heat derived from the heated gases into power, and circulating the heated air using the thermoelectrically generated power. The appliance may also be battery-powered.

### CROSS-REFERENCE TO RELATED APPLICATIONS

This invention claims the benefit of Provisional Application No. 60/430,046 entitled Self-Powered Barbecue Grill filed Dec. 2, 2002 and No. 60/431,224 entitled Self-Powered Cooking Appliance filed Dec. 6, 2002, each being filed in the name of the inventor hereof and being incorporated herein.

### BACKGROUND

The present invention relates to a cooking appliance, but more specifically to a portable oven or grill that includes power-augmented or self-powered air circulation and/or temperature control within a cooking chamber.

In contrast to conventional indoor electric ovens and grills, most outdoor cooking appliances use natural convection to vent hot gases of burning fuel (gas or solid) directly onto a cooking surface. This has the advantage of obtaining smoke or grilled flavoring, but provided uneven cooking since heating was limited to the region of natural convection. To obtain a wider range of heat dispersion, the cooking region was raised above the heat source and/or baffles were added to disperse convection flow more evenly, but this added bulk to the appliance and the heated region may still be limited. It is also sometimes desirable for baking or other types of cooking; however, to avoid food dehydration caused by venting gases directly upon foods in a cooking region. Preparing pizzas, meat wraps, breads, cakes, and pastries, to name a few, and even most meats and fish, should avoid such dehydration as much as possible to retain tenderness, flavor, and moisture. It is also desirable to control temperature more precisely, especially for bread-type food items.

### SUMMARY

One embodiment of the invention comprises a cooking appliance that includes a housing to define a cooking region; a firebox that generates heated gases; a channel that directs heated gases, or air that is heated by the heated gases, from the firebox region to the cooking region; a blower or fan in communication with the channel to move heat into the cooking region; and a source of power, such as a battery or thermoelectric converter that derives power from heat of the firebox, in order to power the blower or fan.

Another aspect of the invention comprises a method of cooking that includes the steps of providing a cooking region; generating heated gases; channeling heated gases, or air that is heated by the heated gases, towards the cooking region; thermoelectrically converting into power waste heat derived from the heated gases; and conveying heat into the cooking region using the power.

By the above-stated apparatus and method, it is a feature of the present invention to overcome traditional design constraints of grills and ovens by providing power-assisted forced-air routing of heat and/or temperature control whereby to enable placement of the heat source at any location about the interior or exterior of a appliance housing.

It is another feature of the present invention to provide a self-powered or power-augmented portable gas or solid fuel, e.g., charcoal, cooking appliance that may provide heating of a cooking region free of fuel gases.

In is another feature of the invention to provide a cooking appliance, oven, or barbecue grill having at least one power-assisted hot air ducting channel that conveys heat from a heat source (gas or solid) to a cooking region within the appliance, oven, or grill.

In is another feature of the invention to provide control of hot air flow rate, e.g., utilizing blowers and fans within ducting channels, in order to regulate heat transfer to and cooking time of foodstuff located within a cooking region.

It is another feature of the invention to provide multiple discharge paths from hot air ducting channels directed upon a cooking region in order to effectively apply heat to multiple layered cooking surfaces or grids within the cooking region whereby to increase the effective cooking area.

It is another feature of the invention to provide a cooking appliance having microprocessor-controlled hot and/or ambient air ducting, fuel flow or burn rate, and/or temperature control within a cooking region.

It is another feature of the invention to provide lighting or illumination of a cooking region in the appliance where such lighting or illumination is powered by a battery or thermoelectrically converted energy derived from a heat source of the appliance.

It is another feature of the invention to use thermoelectrically-converted waste heat produced by the cooking appliance to provide power for any accessory of the cooking appliance or for any external accessory of any nature.

It is another feature of the invention to provide at least one sensor or detector, or a visual and/or audible indication of at least one parameter during operation of the cooking appliance, to detect or sense at least one of internal temperature, heat source level, operating efficiency, thermoelectric conversion efficiency, battery level, a characteristic of foodstuff in the cooking region, internal fire, smoke level, readiness of foodstuff, or other parameter detected by the sensor or detector.

It is another feature of the invention to provide control of ambient air heating or cooling (or air ducting) applied to a thermoelectric converter module of a heat generating cooking appliance that also powers a controller, microprocessor, sensor, or detector in order to maintain an operating condition or efficiency of the converter and/or the cooking appliance.

It is yet a further feature of the present invention to provide a method of conveying heat from a source of heat and/or controlling temperature by regulating air flow whereby to enable placement of the fuel source at almost any location about a grill housing.

It is another feature of the invention to provide a method of cooking by providing forced-air ducting to convey heat from a heat source (gas or solid) to a cooking region within the grill.

It is another feature of the invention to provide a method of cooking by providing multiple discharge paths from hot air ducting channels, and directing hot air from such channels upon a cooking region within a cooking appliance in order to effectively apply heat to multiple layered cooking surfaces or grids within a cooking thereof region whereby to increase the effective cooking area of the appliance.

It is another feature of the invention to provide a method of cooking by controlling hot and/or ambient air ducting within or about a cooking region, regulating fuel flow or burn rate of fuel in a firebox, and/or controlling temperature control within a cooking region of a cooking appliance.

It is another feature of the invention to provide a method of cooking in low light conditions by generating a source of power by thermoelectric conversion of heat energy from a barbecue grill and utilizing the power to illuminate a cooking region of a cooking appliance, such as a barbecue grill or portable oven.

It is another feature of the invention to provide a method of cooking by sensing a condition and indicating a parameter during operation of a cooking appliance where such parameters includes at least one of internal temperature, heat source level, operating efficiency, thermoelectric conversion efficiency, a characteristic of foodstuff in the cooking region, internal fire, smoke level, or other parameter detected by a sensor.

It is another feature of the invention to provide a method of cooking by controlling ambient air heating or cooling (e.g., air ducting) applied to a thermoelectric converter module that also powers the controller in order to maintain a predetermined operating condition of such converters.

As an alternative to thermoelectric converter modules or battery powering, it is yet another feature of the invention to achieve the above-stated features using alternating power line power to power ducting, sensors, indicators, and/or controllers.

Another feature of the present invention includes providing a pressurized compartment for expediting cooking and/or to retain nutrients, flavor, and moisture within a cooking region.

Another feature of the invention provides a cooking appliance having microprocessor-controlled air ducting, fuel flow or burn rate, and/or temperature control within a cooking region.

Another feature of the invention provides lighting or illumination of a cooking region in the appliance where such lighting or illumination is powered by thermoelectrically converted energy derived from a heat source of the appliance or grill.

Another feature of the invention provides sensors as well as a visual and/or audible indication of parameters during operation of the cooking appliance, including at least one of internal temperature, heat source level, operating efficiency, thermoelectric conversion efficiency, a characteristic of foodstuff in the cooking region, overcooking, readiness of foodstuff, or other parameter detected by a sensor.

It is another feature of the invention to provide a method of cooking by sensing a condition and indicating a parameter during operation of a cooking appliance, where such parameters includes at least one of internal temperature, heat source level, operating efficiency, thermoelectric conversion efficiency, a characteristic of foodstuff in the cooking region, internal fire, or other parameter detected by a sensor.

Other aspects of the invention are apparent from the following description taken in connection with the accompanying drawings. The invention, though, is pointed out with particularity by the appended claims.

### BRIEF DESCRIPTION OF THE DRAWINGS

FIG. 1A depicts a cooking appliance that includes assisted air circulation from a heat exchanger to a cooking region according to one aspect of the present invention.

FIG. 1B shows the appliance of FIG. 1A in a closed condition.

FIG. 1C shows an arrangement of cooking grids positioned in the base of the appliance of FIG. 1A.

FIG. 1D shows an alternative housing of a cooking appliance embodying a cooking region according to another aspect of the invention, and that includes an observation window to permit visual inspection of food items as well as a partitioned lid that may be hinged on any edge thereof.

FIG. 2 shows another housing configuration of a cooking appliance embodying a cooking region according to another aspect of the invention, which also includes an observation window to permit visual inspection of food items as well as an enameled or cast iron cover plate to provide a direct heat heating surface.

FIGS. 3A and 3B show a firebox and gas burner that may be used with the appliance of FIG. 1A.

FIG. 4A is a partial cut-a-away perspective view of an exemplary heat exchanger showing circulation fans that may be utilized with the appliance of FIG. 1A.

FIG. 4B shows a set of fan motors, thermoelectric converter, and controller associated with the heat exchanger of FIG. 4A to effect controlled circulation of heated air through the heat exchanger.

FIG. 5 shows an arrangement of heat exchanging plates that facilitate the exchange of heat energy between heated gases of burning fuel and air flowing inside the heat exchanger.

FIG. 6 shows a series of externally encircling and internal longitudinally extending fins attached to tubular elements that provide an alternative arrangement for exchanging heat energy.

FIG. 7 shows an exemplary control algorithm that may be employed to control the temperature of the cooking region of the appliance of FIG. 1A.

FIG. 8 illustrates a control algorithm that may be employed to control the thermoelectric converter.

FIG. 9A depicts a cooking appliance, e.g, a grill or oven that includes force-air circulation from a heat source according to one aspect of the present invention.

FIG. 9B shows the appliance of FIG. 9A in a closed condition.

FIG. 10 depicts an alternative air deflection or routing arrangement that may be employed in an appliance according to another aspect of the present invention.

FIG. 11A is perspective view of an inverted lid of a cooking appliance embodying a blower fan that routes heated gases through a channel into a cooking region of the appliance.

FIG. 11B shows a cross-section along line A-A for FIG. 11A and includes additional components in accordance with another aspect of the present invention.

FIG. 12A is perspective view of an inverted lid of a cooking-appliance embodying a series of internal blower fans that route heated gases through a channel into a cooking region of the appliance.

FIG. 12B shows a cross-section along line B-B for FIG. 12A and includes additional components in accordance with another aspect of the present invention.

FIG. 12C is a perspective view of a bulkhead that supports the series of blower fans of FIG. 12B.

FIG. 13A is perspective view of an inverted lid of a cooking appliance embodying a baffle that helps route heated gases into a cooking region of the appliance.

FIG. 13B shows a cross-section along line C-C for FIG. 13A and includes additional fan and control components in accordance with another aspect of the present invention.

FIG. 14A is a partial cut-a-away perspective view of the rear firebox section in the base of the appliance shown in FIG. 9A.

FIG. 14B shows an additional improvement including an insulating barrier to help cool the exterior surface of the base of FIG. 14A.

FIG. 15 shows a charcoal basket insertable in the firebox of the appliance of FIG. 9A, as well as a divider that partitions the basket into multiple compartments.

FIG. 16 shows yet another improvement including illumination lamps and windows that may be incorporated with a cooking appliance according to another aspect of the present invention.

FIG. 17 shows yet another improvement including a smoker basket for hold wood chips and a water reservoir for maintain moisture in the cooking region of an appliance according to yet another aspect of the present invention.

### DESCRIPTION OF ILLUSTRATIVE EMBODIMENTS

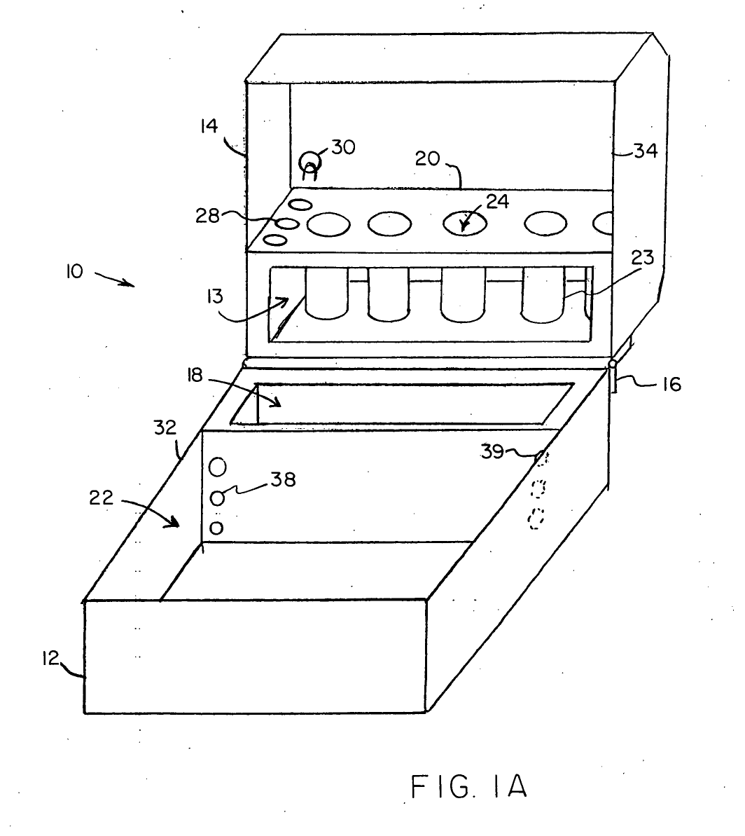

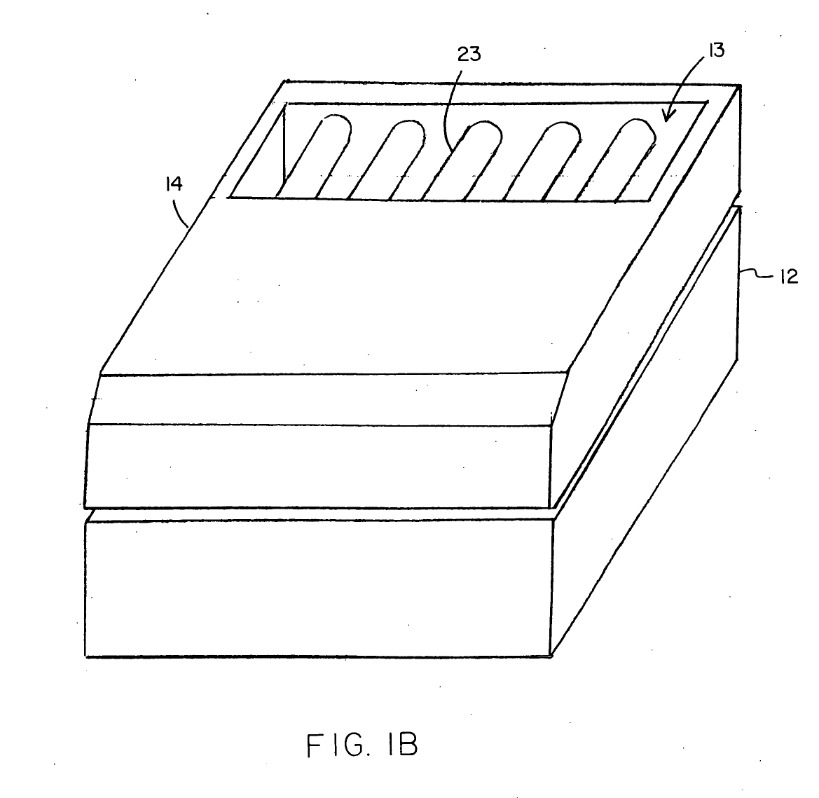

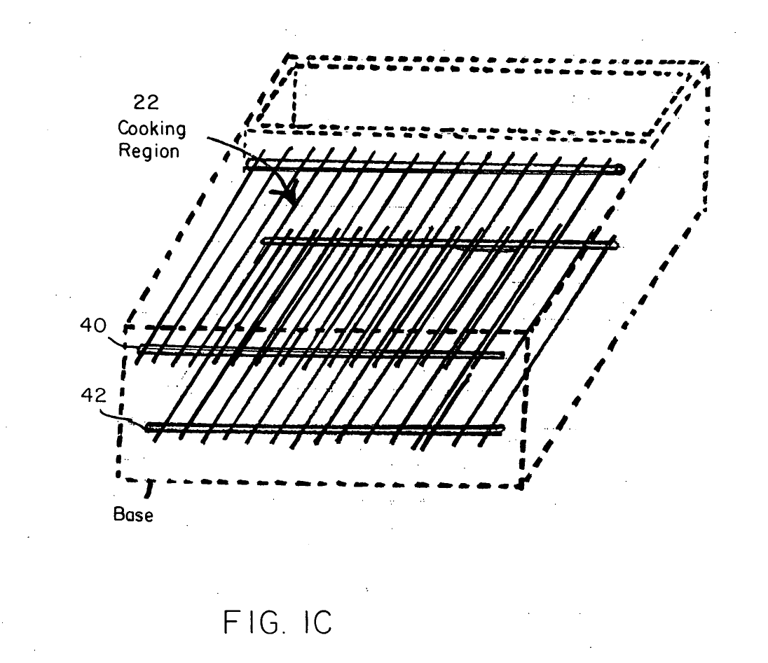

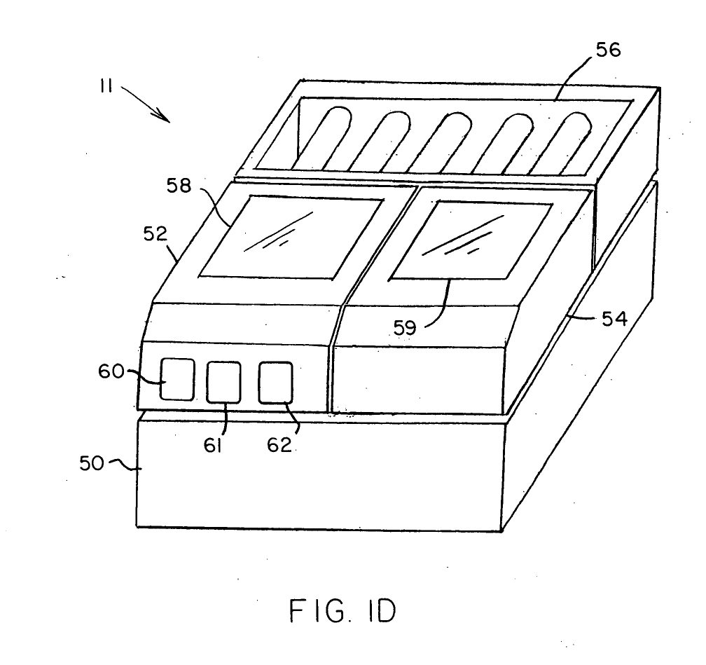

FIG. 1A shows a portable oven or appliance 10 having base 12 that pivotally supports lid 14 on a hinge 16 to define a cooking region 22 in a housing defined by the base and lid. Appliance 10 may have a cast or sheet metal construction, and include legs (not shown) of varying lengths to provide freestanding or tabletop mounting and may also include a handle (not shown). The base and lid may include thermal insulation to improve the overall thermal efficiency of the appliance. Insulation may be accomplished in a conventional way by providing a double-wall structure providing an air gap insulation around the cooking region. Base 12 includes a firebox 18, which houses a fuel source during operation of the oven. Conventional fuel sources include gaseous fuels (propane, butane, or natural gas (methane)), solid fuels (wood or charcoal), or a combination thereof, which oxidize at temperatures of 1100 to 1300 degrees Fahrenheit.

It has been found that enameled steel suffices for firebox 18 or a lining thereof. Instead of providing a firebox 18 inside base 12, the firebox may be separated from the oven and ductwork may channel or direct heated gases to a cooking region 22.

Although shown as having a single-wall construction, lid 14 may have a double-wall construction or heat shield that provides an air-insulating barrier of about four to ten millimeters from the outer wall of lid 14. Instead of air, an insulating material, e.g., fiberglass, may also be incorporated between the inner and outer walls of the lid. Base 12 may have a similar double-walled or layered construction and, in addition, may include sufficient and adequate bottom insulation and/or air gap separation to enable safe placement of the appliance 10 directly on a combustible, e.g., a wooden or plastic table or surface.

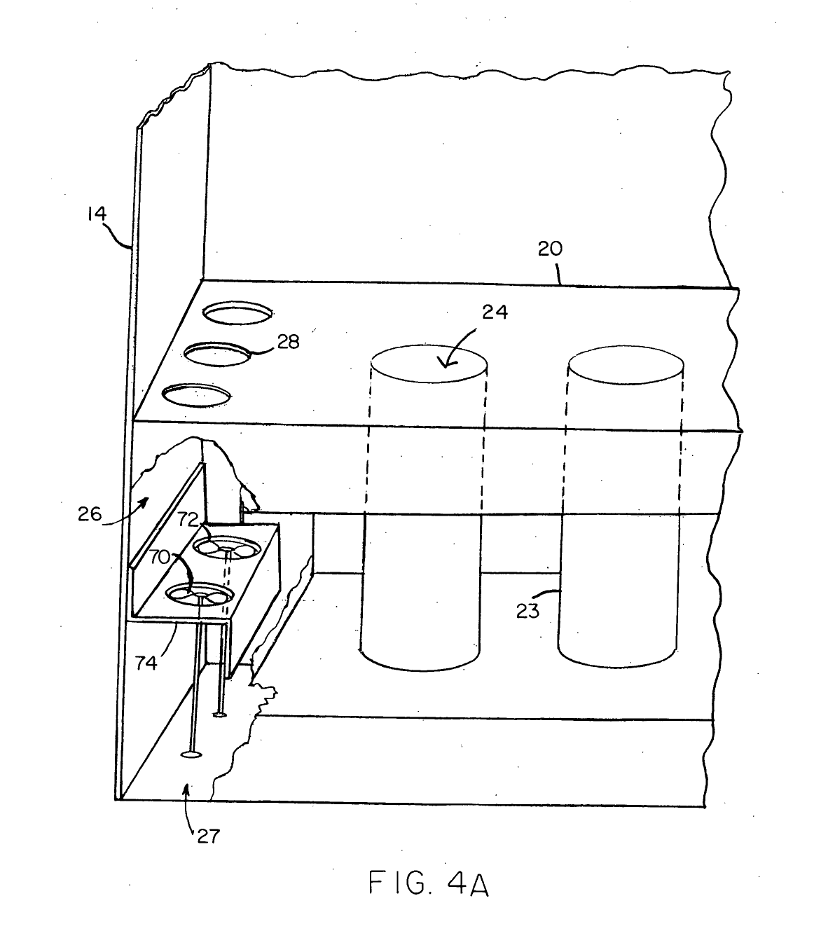

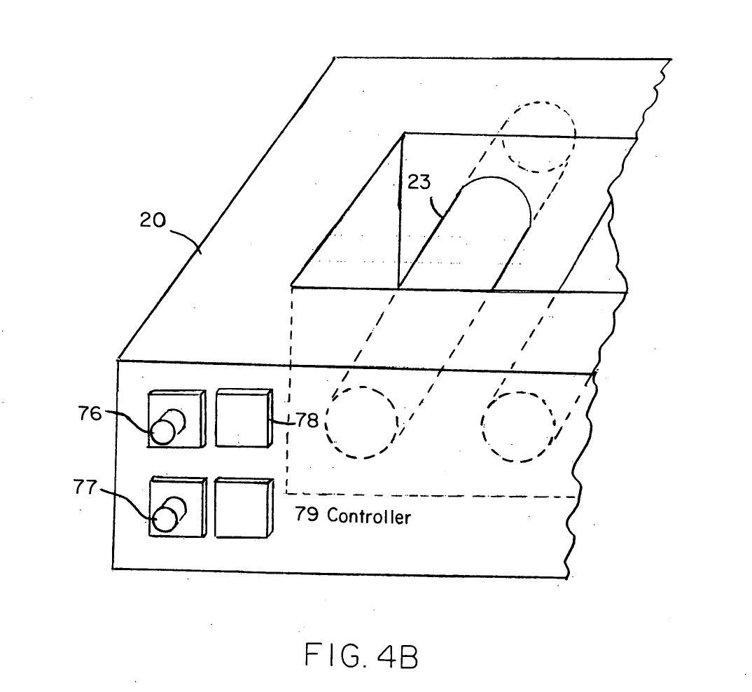

According to a principal aspect of the invention, lid 14 incorporates a heat exchanger 20 that directs heated air rising from firebox 18 so that heated air may be circulated with a cooking region 22 when lid 14 is closed upon base 12, as shown in FIG. 1B. When so closed, heated firebox gases escape around tubular conduits 23 through opening 13 of the rear of lid 14. Exemplary heat exchanger 20 includes an internal channel or chamber 26 (FIG. 4A) through which air is circulates by blowers or fans before it is discharged through a series of ductways 24 into the cooking region 20. Ductways 24 preferably comprise a series of tubular conduits disposed in heat exchanging relationship with heated gases from the firebox 18. A group of one or more return ports 28 preferably located at both sides of the air heat exchanger 20 receive air from the cooking region 22 when the lid 14 is closed upon the base 12. The air is then heated as it flows within chamber 26 through the ductways 24 where it extracts heat as it flows through the tubular conduits 23.

Optionally and additionally, a circulation path may also surround the periphery of firebox 18 in order to extract heat directly therefrom. In that case, a series of inlet ports 38 communicating with the cooking region may be located at one side of the firebox 18 while a series of discharge ports 39 are located at the other side. Baffles may be incorporated in and around the discharge ports and additional ductways and channels may be incorporated in the cooking region to distribute heated air more evenly in and about cooking region 22 or, to reduce any air-drying effect of the circulating air, to redirect pathways of discharged air away from a cooking surface embodying foodstuff. Unlike prior portable gas and charcoal grills and ovens, these addition elements help meet the goal of providing a “low profile” oven where heated air is brought from a heated region, e.g., a heat exchanger, to a cooking region.

Advantageously, heated gases of the firebox do not enter cooking region 22 thereby obviating any health risk associated with oxidizing gases of propane, wood, or charcoal fuel entering the cooking chamber onto foodstuff that may be placed on racks 40, 42 (FIG. 1C). Furthermore, since the region 22 may essentially be sealed from an external environment, moisture, nutrients, and flavor of cooking foodstuff remain in the cooking region. Such a cooking region is ideal for baking certain pastries, pizzas, and bread dough. If desired, respective lips or mating edges 32, 34 (FIGS. 1A) of the lid and base may be designed to form a pressurizing seal to enable pressure-cooking in cooking region 22, which reduces the cook time of most foods. Illumination lamp 30 provides lighting of the cooking region 22.

FIG. 1D shows an appliance 11 having double, top-hinged lids 52, 54 that close against the base 50 to define a cooking region 22 underneath. Lids 52, 54 may be hinged at the sides, rear, or front of base 50, or may otherwise be positionable over the base without hinges. Here, it is seen that the lid portions 52, 54 are separated from the heat exchanger section 56 so that they do not interfere with the with heat exchanger operation when opened. Lids 53, 54 may also include respective windows, e.g., Pyrex or other thermal glass or plastic, to permit visual observation of the cooking region. Internal illumination lamps will aid the observation. In addition, appliance 11 includes a controller or thermal switch 60, a temperature gauge 61, and/or a thermoelectric converter 62 to converts heat into electrical power. At least one blower or fan is also provided to circulate heated air, in a closed loop, between the heat exchanger and the cooking region. A controller or thermostat 60 controls the blowers and/or fuel level to maintain a desired temperature within the cooking region.

Conventional thermoelectric converters are berrilium telluride (Bi—Te) based. Thermoelectric converters are commercially available from Hi-Z Technology, inc. of San Diego, Calif. Utilization of such thermoelectric converters is also described in copending application Ser. No. 09/909,789 filed Jul. 23, 2001, in the name of the inventor hereof, which is incorporated by reference. Because the conversion efficiency of thermoelectric converters is hot-side-to-cold-side temperature dependent, another aspect of the present invention includes maintaining a desired or optimum temperature differential between the hot side and cold side of the thermoelectric, which is about 200 degrees Celsius. In addition, another aspect of the invention includes protecting the converter from damaging heat, which is about 400 degrees Celsius. To accomplish temperature optimization and thermal protection, the converter 62 may be positioned at a particular location on lid 14 or base 12 that does not exceed heat-damaging temperature. The size and configuration of the appliance, as well as the size and configuration firebox 18 in part dictate that location. Rather than providing passive protection, a cooling fan may direct ambient air directly on converter 62, as subsequently described. An ambient air intake vent may also be incorporated in proximity of converter 62 specially designed to intake cooling air should the temperature exceed a given threshold.

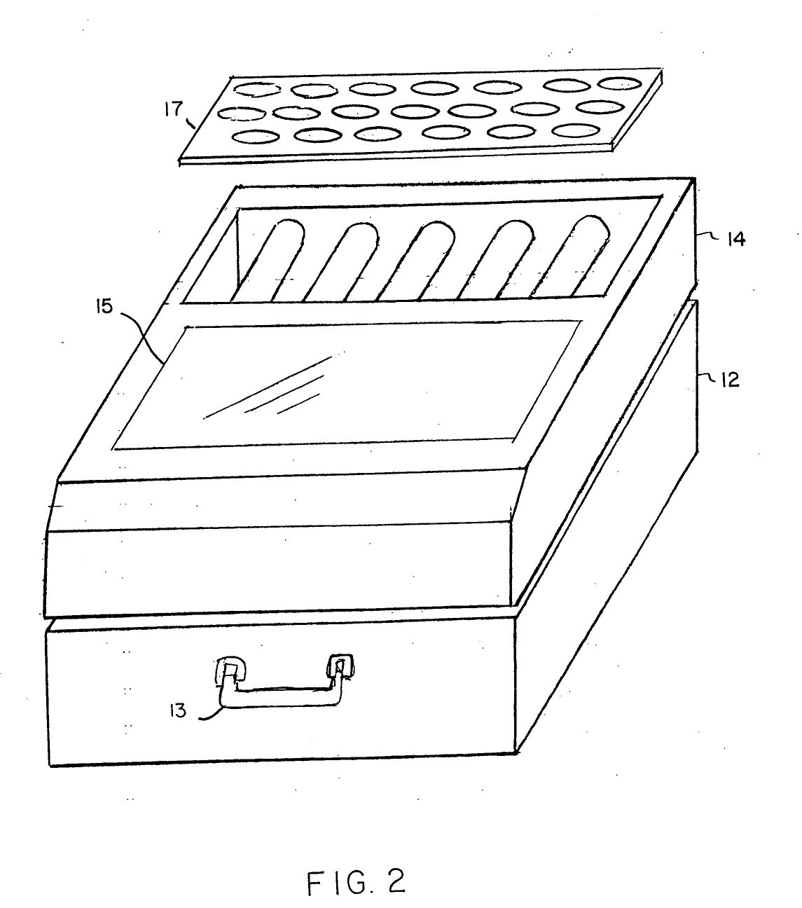

FIG. 2 shows appliance 10 including a handle 13 on the base 12, an observation window 15 in the lid 14, and a ventilation plate 17 that covers the top portion of the lid above the heat exchanger. Plate 17 provides an additional heater for warming or direct heat. Lid 14 may be pivotally attached to base 12, or may removably rest on top of base 12, in which case a handle thereon is provided.

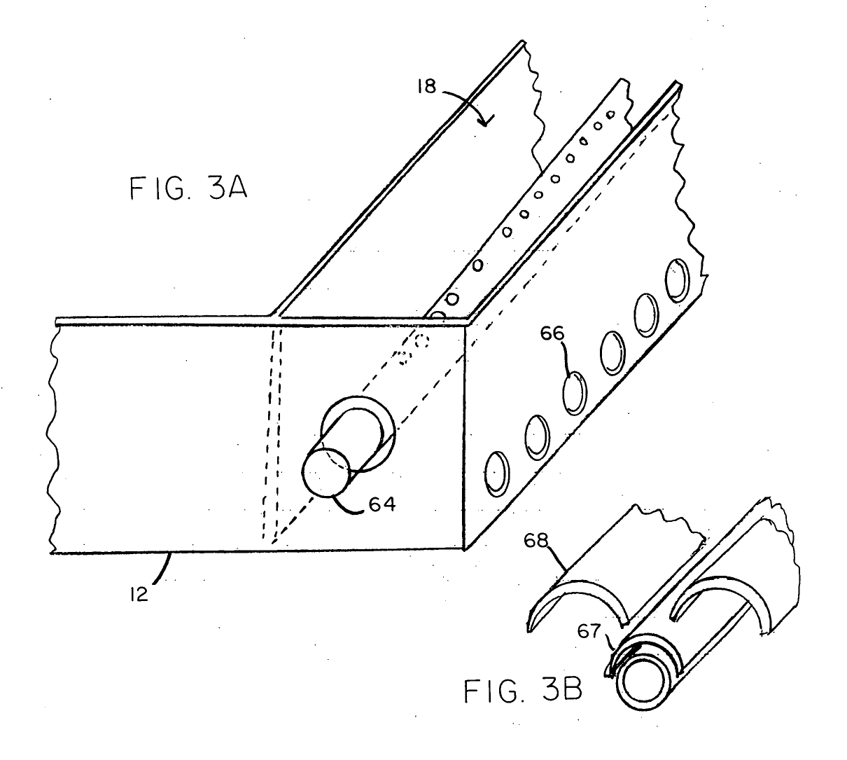

FIG. 3A shows an exemplary gas-fired firebox 18 located in the rear of base 12 having a tubular burner element 64 transgressing firebox 18. The burner element 64 preferably comprises stainless or cast iron includes a series of gas orifices. A ceramic burner may also be used. The rear of base 12 may additionally include ventilation holes 66. Alternatively, the portion of the base underlying the burner may be open or include ventilation holes. FIG. 3B shows a series of heat dispersion baffles 67, 68, and 69 that may be used with the burner element to protect the burner and/or to reduce “hot spots” in heated gases rising from firebox 18 into the heat exchanger. Instead of incorporating a gas burner, firebox 18 may comprise a charcoal holder to provide a source of heat for the heat exchanger.

FIGS. 4A and 4B shows an exemplary structure to circulate heated air between heat exchanger 20 and the cooking region 22 of appliance 10 of FIG. 1A. In the illustrated embodiment, one or more fans 70, 72 located in chamber 26 are driven by respective motors 76, 77 powered by a thermoelectric converter 78. The speed or on-off switching of motors 76, 77 may be thermostatically controlled by controller 79 according to a desired temperature of cooking region 22. Controller 79 may comprise a thermostat.

Fans 70, 72 respectively connect to motor shafts 71, 73 extending through the housing of chamber 26. A chamber bulkhead 74 partitions low pressure and higher pressure compartments of the chamber so that a controlled amount or volume of air in cooking region 22 is drawn through the orifices 28 into the chamber 26, and then forced into chamber partition 27 before being discharged through channels 24 of the tubular conduits 23. Heat exchanger 20 may also include a similar set of orifices 28 at the other end to provide more even circulation. The volume of air discharged into the cooking region 22 through channels 24 becomes heated due to placement of the tubular conduits 23 in heat exchanging relation with heated gases of the firebox 18 (FIG. 3A). The invention, though, is not limited to the illustrated heat exchanging structure, it being understood that such structure may have varied configurations as known in the art. As mentioned above, baffles, channels, ducts, etc. may be incorporated in the appliance 10 to cooperate with the discharged air path to reroute heated air within the cooking region 22.

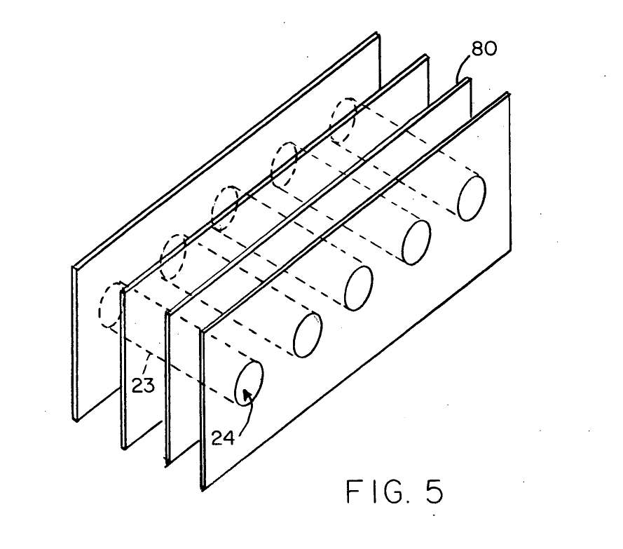

FIG. 5 shows a preferred structure for exchanging heat energy between heated gases of firebox 18 and tubular conduits 23 that comprises a series of metal plates 80 though conduits 23 are journalled. The material of the plates and tubes may be a metal having good heat transfer characteristics, such as copper, aluminum, or cast iron, or may simply comprise enameled sheet metal, which also provide acceptable heat transfer. The number and spacing of the tubes 23 and plates 80 may also vary.

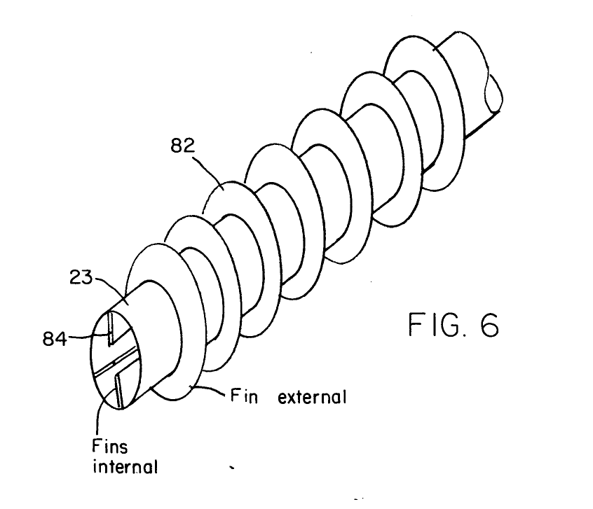

FIG. 6 shows yet another structure for tubular conduits 23. There, a series of fins 82 are provided to draw heat from surrounding heated gases through the wall of conduit 23. To improve heat transfer to the volume of air circulating through the conduits, internal fins 84 may be placed inside the conduits. In one embodiment, fins 82, 84 are spot-welded to the tube 23, and then the spot-welded structure is dipped in dipped in molten silica or enamel, cooled, and solidified to establish a heat exchanging glass-like connection between the fins and the tube.

Instead of circulating heated air from a heated region, the appliance may alternatively convey heat energy by conduction or thermal transfer. An exemplary structure may comprising placing cast iron, copper, or aluminum probes or fins both in the cooking region and the path of heated gases to convey heat energy to the cooking region. Blowers may be included in the cooking region to distribute heat therein.

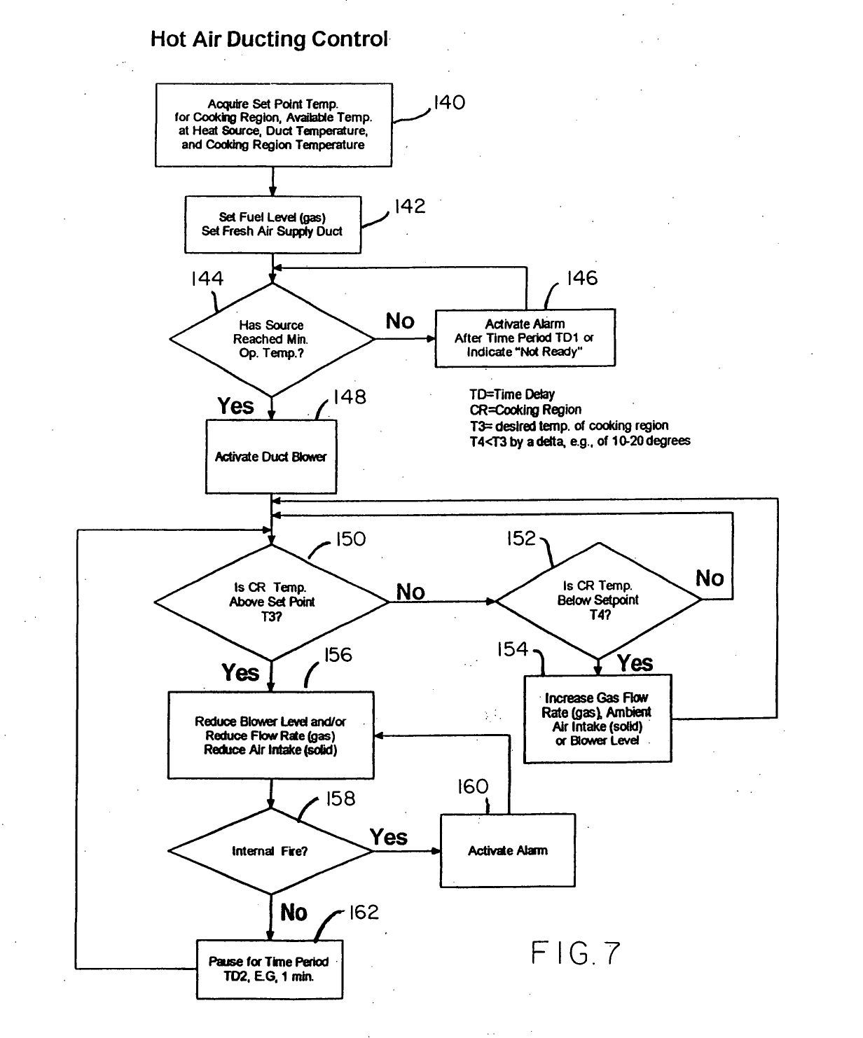

FIG. 7 illustrates an algorithm implemented by controller 79 (FIG. 4B) to control circulation or routing of heated air from heat exchanger 20 to an area in and about cooking region 22. Initiation of a cooking cycle begins by the user manually starting a cooking cycle and/or setting a cook temperature desired for the region 22. After firing the fuel, heat begins to build, thermoelectric conversion initiates, and controller 79 turns on. When an optional battery is provided, controller 30 readies itself in response to user activation.

In an embodiment providing active temperature control, the control algorithm begins at step 140 by the controller 79 acquiring a set point temperature desired for region 22 and monitoring heat in chamber 26. A set point temperature may be established by a conventional bimetallic element or rheostat that cooperates with controller 79 to control temperature. Alternative embodiments, however, include passive temperature control where the size of the firebox relative to the cooking region defines a temperature range. In addition, in a control system including automated control of gas flow rate or pressure, or air dampers in a charcoal embodiment, the controller 79, at step 142 more actively controls the output of the firebox and thus the temperature of cooking region 22. Otherwise, step 142 is skipped and a test is performed at step 144 to determine whether sufficient power exists to drive operating components, e.g., fans, of the appliance. If negative, the controller 79 loops between steps 144 and 146 until an operating temperature is reached or a time-out occurs, which may optionally invoke an alarm to notify the user of inoperability of the appliance. When a minimum operating temperature is reached at step 144, the blowers or fans 70, 72 are activated at step 148 and heated air begins to flow into the cooking region. In the case where power is supplied by a battery, fans or blowers may initiate immediately or in response to a user-activated switch.

Next, the controller monitors via a temperature gauge associated with controller 78 the temperature of the cooking region (CR) temperature at step 150 to assure that it stays at or near a set point desired by the user. The temperature gauge preferably comprises a convention thermocouple or probe protruding through a wall of heat exchanger 20 into chamber 26. It is assumed that the temperature in chamber 26 as detected by temperature gauge bears a direct relation with the temperature of the cooking region. Alternatively, temperature probe may be relocated to the cooking region, or an addition temperature probe may be included in the cooking region. If the detected CR temperature is not above a set point range, the controller 30 tests at step 152 whether it is below the desired set point range. If not, the controller 79 loops back to step 150 to again test the CR temperature. If the CR temperature is found to be above the set point range at step 150, the blower level may be reduced, the gas flow rate may be reduced, or air intake dampers of the charcoal firebox may be restricted. These controls are implemented at step 156. After taking steps to reduce the internal temperature of the cooking region, an additional test for fire is made at step 158. A flame detector (not shown) may be used for this purpose. If a flame is detected, an alarm is activated at step 160. If no flame is detected, the controller loops back to step 150 after a brief pause at step 162 according to an effective response time for variation of temperature.

If, on the other hand, the CR temperature was found during the test at step 152 to be below the set point, the controller at step 154 may effect an increase in gas flow or air damper opening. In addition, the blower level may be increased. After a pause, if any, according to response time for active temperature control, the controller loops back to step 150 to resume testing of cooking region temperature.

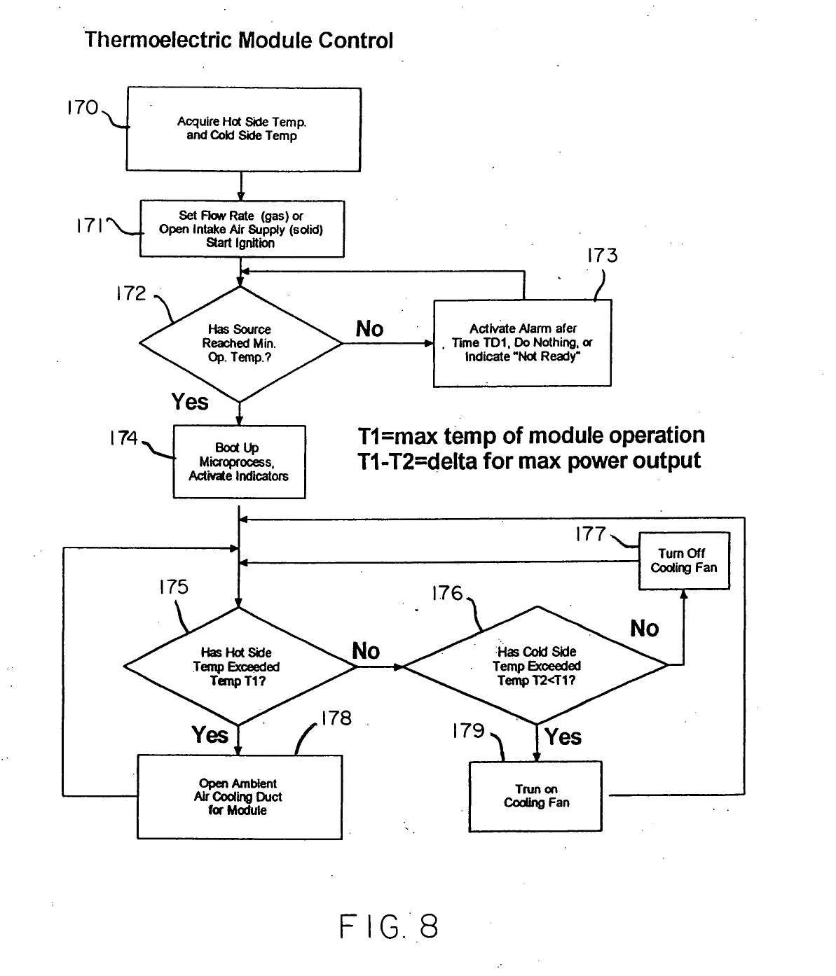

FIG. 8 illustrates an exemplary temperature control algorithm for thermoelectric converter 78 (FIG. 4B) useful for preventing overheating and/or maintaining a desired operating efficiency. At step 170, the controller (if power is available) acquires the hot side and/or cold side temperature of the thermoelectric module. Each of the hot side and cold sides of converter 78 may include a heat sink, e.g., a series of fins, to facilitate capture and removal of heat energy. In addition, the hot side heat sink may protrude through a wall of heat exchanger 20 inside chamber 26.

In certain cases, the temperature of one side of the thermoelectric converter may bear a direct relation with the temperature of the other side based on heat transfer characteristics of the converter. In that case, only the temperature of one side requires monitoring. At step 171, a user may manually perform setting a gas flow rate or damper opening. After obtaining the thermoelectric converter temperature, the controller examines at step 172 whether the converter has reached a minimum operating temperature. If negative, the controller continues to loop between steps 173 and 172 continuously or until reaching a time out condition whereupon an alarm is initiated. If, on the other hand, the converter reaches minimum operating temperature during step 172, the controller boots up or otherwise becomes active.

In the case where no external power is available, a thermal switch is simply used to energize the controller when the heat source reaches operating temperature whereupon various temperatures are then sensed. In that case, the control algorithm begins at step 174.

After commencement of the control process at step 174, the controller 79 examines at step 175 whether the hot side temperature of the thermoelectric converter has exceeded a temperature T1 indicative of a maximum safe operation temperature. Typically, T1 is about 500 degrees Fahrenheit for continuous operation, and a couple hundred degrees higher for intermittent operation. If the test at step 175 is negative, the controller examines at step 176 whether the cold side temperature has exceeded a temperature T2<T1 that defines a temperature differential providing a desired operating efficiency of the thermoelectric module. Typically, T2 is about 170-200 degrees Fahrenheit, which provides a delta of about 300 degrees to provide a fairly optimum operation or power output. A commercially available thermoelectric converter of about twenty-five square centimeters in surface area produces about ten to twenty watts of power. If the test at step 176 is negative, the controller turns off any previously turned-on cooling fan at step 177, and returns to step 175 to repeat the temperature examination process by looping between steps 175, 176, and 177.

If during the test at step 175 the controller detects an excessive temperature at the hot side of the thermoelectric module, it turns on a cooling fan motor (not shown) or opens a cooling vent to pass cool air over or exhaust hot air from the converter. Thereafter, the controller continues to loop between steps 178 and 175 until dissipating the excessive heat whereupon the controller proceeds again to step 176 to test the delta condition for maintaining a desired operating efficiency and power output. If during the delta test at step 176 the controller detects a threshold temperature T2 or higher that reduces the desired temperature differential, the controller turns on cooling fan motor 65 (FIG. 3B) to lower the cold side temperature of the thermoelectric module and then returns to step 175. According to the just-described algorithm, it is seen that the controller performs two functions—to prevent overheating as a priority and secondly to maintain a temperature differential between hot and cold sides of the thermoelectric converter. Separate and independent temperature control may also be provided for these functions or for each side of the converter.

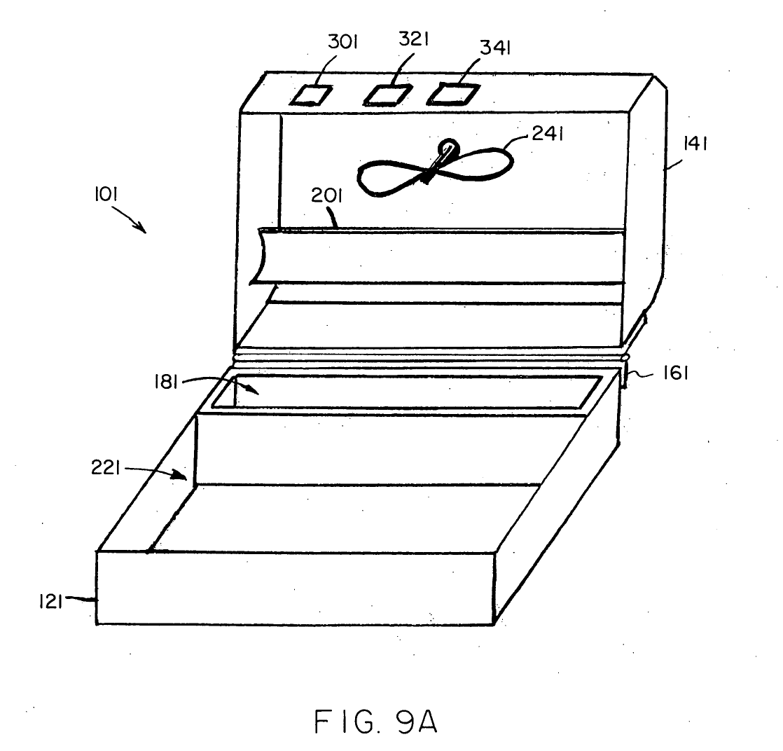

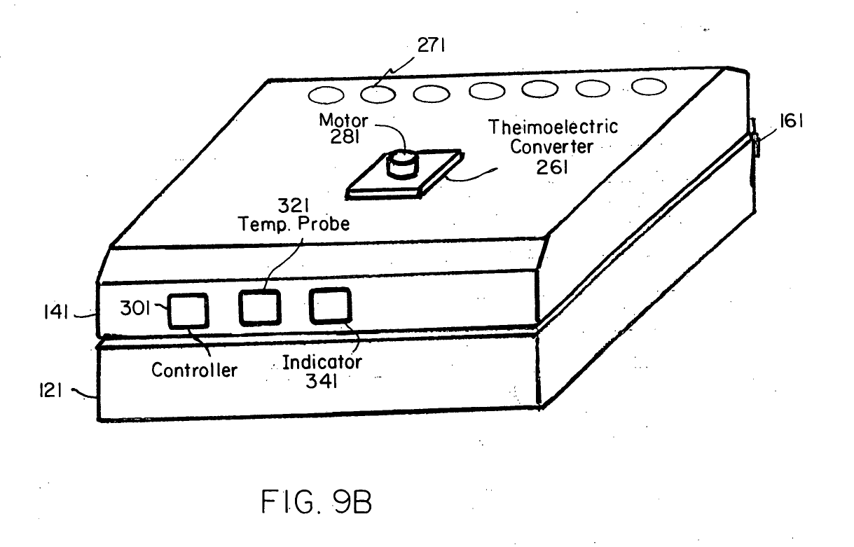

FIG. 9A shows another embodiment of the invention where the fuel gas itself is channeled directly from a source of heat directly into the cooking chamber by way of forced air circulation. As shown, a barbecue grill 101 having base 121 that pivotally supports lid 141 by a hinge 161. Grill 101 may have a cast or sheet metal construction, and include legs (not shown) of varying lengths to provide freestanding or tabletop mounting. Base 121 includes a firebox 181, which houses a fuel source during operation of the grill. Conventional fuel sources include gaseous fuels (propane or natural gas), solid fuels (wood or charcoal), or a combination thereof, which oxidize at temperatures of 1100 to 1300 degrees Fahrenheit. It has been found that enameled steel suffices for firebox 181 or a lining thereof. Instead of providing a firebox 181 inside the grill base 121, the firebox may be separated from the grill and ductwork may channel or direct heated gases to the cooking region.

According to an aspect of the invention, lid 141 incorporates an enameled steel baffle or deflector 201 and fan 241 that direct heated air rising from firebox 181 into cooking region 221 when lid 141 is closed upon base 121, as shown in FIG. 9B. Although shown as having a single-wall construction, lid 141 may have a double-wall construction or heat shield that provides an air insulating barrier of about four to ten millimeters from the outer wall of lid 141. Instead of air, an insulating material, e.g., fiberglass, may also be incorporated between the inner and outer walls. Deflector 201 forms a channel or duct along the inner top surface of lid 141. Metallic fan 241, made of aluminum or steel, directs heated air and gases from firebox 181 downward into the cooking region 221 by drawing the heated air and gases from the channel formed by air deflecting baffle 201. As described later, ducting paths may also be used to perform the air routing function of air deflecting element or baffle 201. In addition, some of the heated gases escapes through as series of exhaust ports 271 disposed in the top of lid 141, as shown in FIG. 9B.

Advantageously, a fan motor 281, which drives fan 241, is powered by at least one thermoelectric converter 261, as depicted in FIG. 9B. Conventional thermoelectric modules berrilium telluride (Bi—Te) based. Because the conversion efficiency of thermoelectric converters is hot-side-to-cold-side temperature dependent, an aspect of the present invention includes maintaining a desired or optimum temperature differential between the hot side and cold side of the thermoelectric, which is about 200 degrees Celsius. In addition, another aspect of the invention includes protecting the converter 261 from damaging heat, which is about 400 degrees Celsius. To accomplish temperature optimization and heat protection, the converter 261 is positioned at a particular location on lid 141 or base 121 that does not exceed heat-damaging temperature. That location is in part dictated by the size and configuration of grill 101, as well as the size and configuration firebox 181. Rather than providing passive protection, motor 281 may also include a cooling fan that direct ambient air directly on converter 261, as subsequently described. An ambient air intake vent may also be incorporated in lid 141 in proximity of converter 261 specially designed to intake cooling air should the temperature exceed a given threshold.

FIG. 9B shows a controller 301 that performs converter optimization and protection function, which is also powered by converter 261. A surface temperature probe placed near the converter 261 may supply controller 301 with information to perform thermal protection, and the surface temperature probe in conjunction with a cold side temperature probe on convert 261 enables controller 301 to monitor and control thermoelectric conversion efficiency. Controller 301 also controls internal temperature of region 221 by regulating gas flow in gas grills, or performing the type of venting disclosed in copending application Ser. No. 09/909,789, mentioned above. In this case, controller 301 uses a temperature signal from probe 321. The size and location of the firebox 181, volume of cooking region 221, and extent of hot air exhaust through exhaust ports 271 are preferably selected to achieve an internal cooking temperature range of 300-650 degrees Fahrenheit for a given quantity, consumption, and type of fuel. Exhaust ports 271, although shown in the top of lid 141, may be located at other regions of grill 101, including the base 121. Instead or in addition to exhaust ports 271, controllable exhaust waste gates actuated under control of controller 301 may also be provided to control internal temperature of region 221 and burn rate of fuel in firebox 181.

An eight-bit microprocessor suffices to provide control functions of controller 301, although a more powerful processor may be used. A bootstrap battery (not shown) may initially energize controller 301 until sufficient thermally converted energy becomes available. Alternatively, controller 301 may be configured via EPROM executable code to boot-up automatically when sufficient thermally converted power becomes available for the controller and other needed components. Thermally converted power may also recharge a rechargeable bootstrap battery. To improve reliability, multiple converters 261 and fan motors may be employed.

Indicator 341 provides visual (e.g., LED lamps, character display panel, incandescent lamps) or audible (e.g., acoustic speaker, tone generator, buzzer, etc.) indications of an operating or alarm condition of grill 101. Indicator 341 may, for example, indicate elapsed time, internal fire, temperature of cooking region, thermal efficiency of the converter 261, power output of converter 261, hot side and/or cold side temperature difference of thermoelectric module 261, output temperature of firebox, motor speed and/or air flow rate, BTU output of firebox (based on temperature in the channel or duct and air flow volume as it relates to fan/motor speed), etc.

Controller 301 provides multiple features. To aid the novice barbecuer, a tap selection region on an input panel provides an announcement of preset cooking times, e.g., by sounding an audible tone or slogan (synthesized voice output), for common food items, i.e., twelve to twenty ounce steaks, eight-ounce hamburgers, hot dogs, four to five pound chickens, etc. Slogans and audible announcements may relate to sporting events (football, racing), a kitchen cliche, or an expression relating to the occasion of grilling. Based on predetermined amounts of imparted cooking energy based on time, temperature, and heat transfer the novice simply activates the appropriate switch associated with the selected region on the panel. Controller 301 senses this. After closing lid 141, the user receives an announcement when the proper amount of energy is imparted to the selected food item. In addition, a series of LEDs (ten to a hundred, for example) either arranged in a preset pattern or located along one or more edges or panels of the grill may be employed to make the announcements.

Excess thermoelectrically generated power may be used for other purposes, such as powering lamps for night time illumination of the cooking or other region about the grill, or for powering external user appliances (mobile phones, computing devices, 12 v appliances). In one particular embodiment, the thermoelectric modules provide a twelve-volt source through a standard cigarette lighter adapter embedded within the base 121 of the grill.

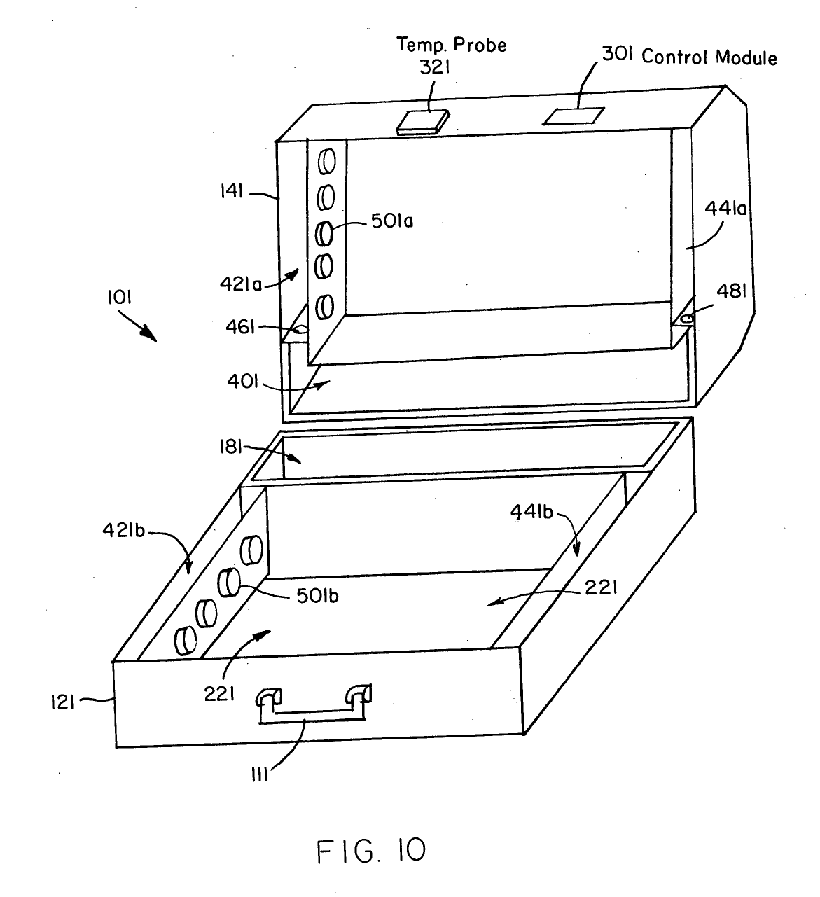

FIG. 10 shows a barbecue grill 101 with handle 111 having an alternative ducting and air deflecting arrangement. When lid 141 closes upon base 121, chamber 401 receives heated gases from firebox 181, which are directed into respective chambers 421a, 441a by blowers or fans 461, 481. Higher pressure in chambers 421a, 441a also pressurizes chambers 421b, 441b and effects an ejection of hot gases through a set of discharge ports 501a and 501b (only one such discharge port in each of chambers 42a and 42b is labeled) into the cooking region 22. The number, size, direction, and configuration of discharge ports 501a, 501b are selected to evenly heat cooking region 221 given the location and size of firebox 181, volume of cooking region 221, placement of food items, flow rate produced by blowers 461, 481, as well as other parameters of grill 101. Blowers 461, 481 as well as the internal temperature of region 221 are controlled by controller 301, as previously described.

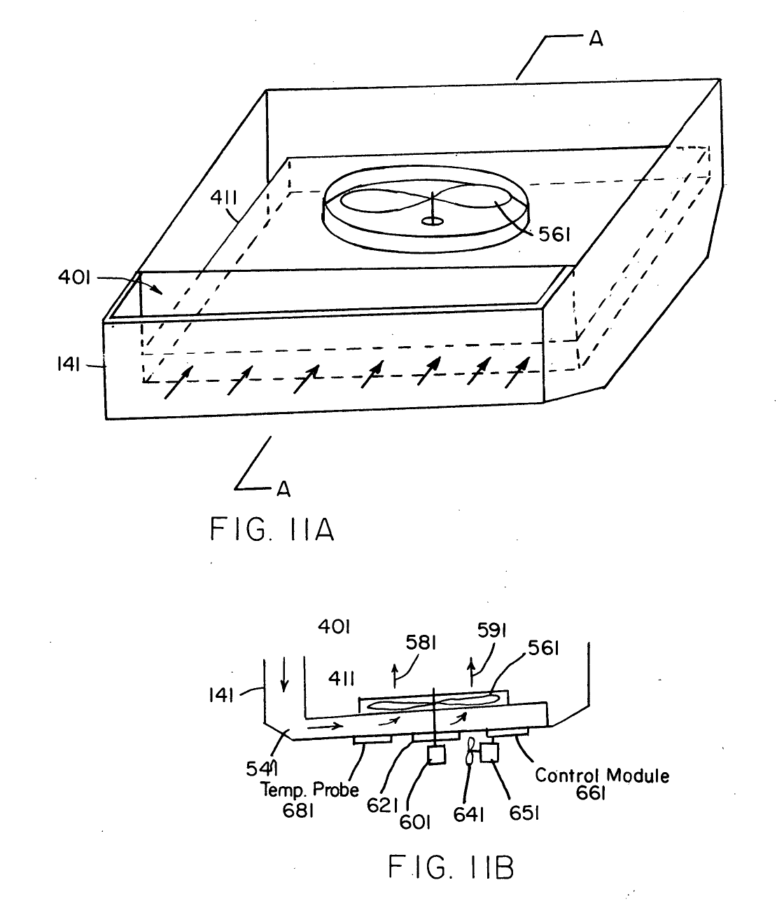

FIGS. 11A and 11B show yet another air deflection or routing arrangement provided in a lid 141, it being understood that air deflection and routing arrangements may also be provided in the base. For convenience, FIGS. 11A and 11B show an inverted lid 141 where chamber 401 receives heated gases from the firebox. The heated gases are then routed by action of fan 561 along path 541 between lid 141 and fan housing 411. Fan 561 forces the heated gases downward into the cooking region through the fan housing 411, as indicated by arrows 581, 591.

Motor 601, which is powered by thermoelectric converter module 621, drives cooking region fan 561. To obtain maximum power output, the impedance of motor 601 and other components drawing power from the converter is closely matched with the internal impedance of the converter module 621. To cool the cool side of the module 621, lid 141 includes a cooling fan 641 and fan motor 651. Module 621 may also include a series of cooling fins to serve as a heat sink. Control module 661 provides on-off control of motor 651 and corresponding fan 641 in accordance with a detected surface temperature around the module 621. A temperature probe 681 placed on the metallic surface of lid 141 near the module 621 senses surface temperature near the module 621. Based on predetermined heat transfer characteristics of the surface material of lid 141 and the module 621, module 661 activates the fan motor 651 to maintain an optimum temperature differential between the hot and cold sides of the thermoelectric module 621. Controller 661 also produces an alarm to warn the user when the surface temperature exceeds a maximum operating level for the module 621. An internal fire may invoke such a warning.

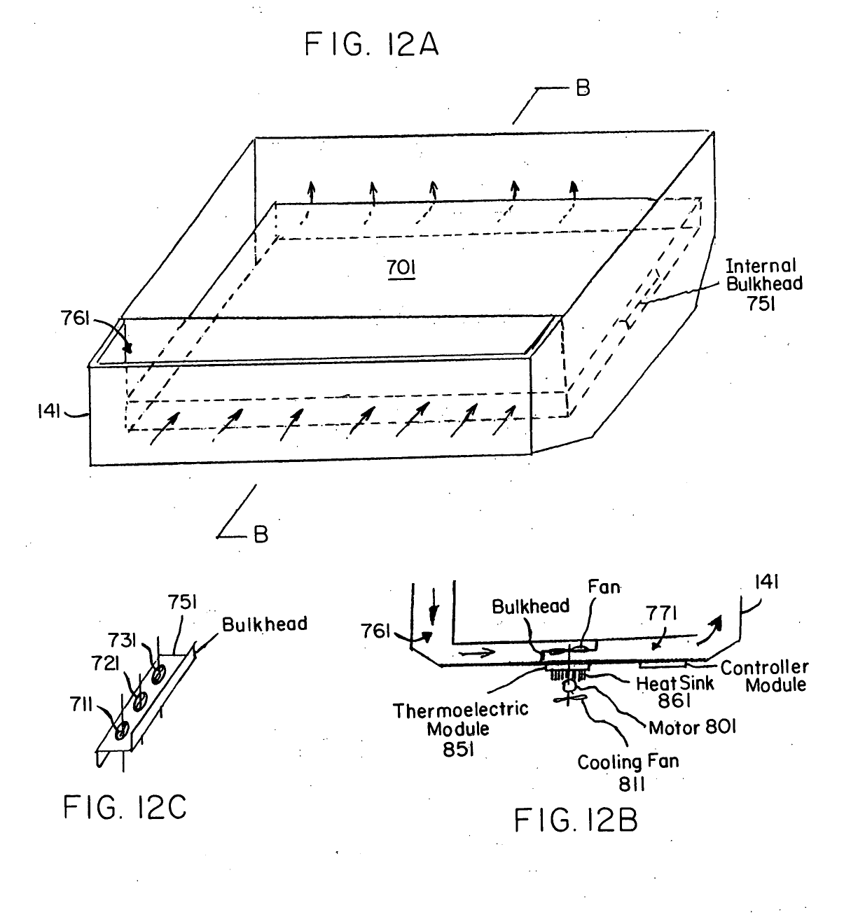

FIGS. 12A, 12B, and 12C show a further embodiment of the air deflection and other aspects of the invention. A panel 701 forms a heated gas channel along the inner surface of lid 141. Instead of using the internal chamber fan 561 of FIGS. 10A and 10B, the embodiment of FIGS. 12A-12C utilizes a series of miniature fans 711, 721, and 731 (FIG. 12C) disposed on a bulkhead 751 that separates compartments 761 and 771 of the heated gas channel. The series of fans move heated gases from compartment 781 to compartment 771, and then outward into the front portion of the cooking region. In this case, each fan motor drives an internal fan 711, 721, or 731 as well as an external cooling fan 811, 821, or 831 (only fan 811 shown) so that only one fan motor 801, for example, is required to drive two fans, one for internal circulation and the other for cooling the thermoelectric converter module 851. Module 851 includes heat sink 861 to facilitate cooling.

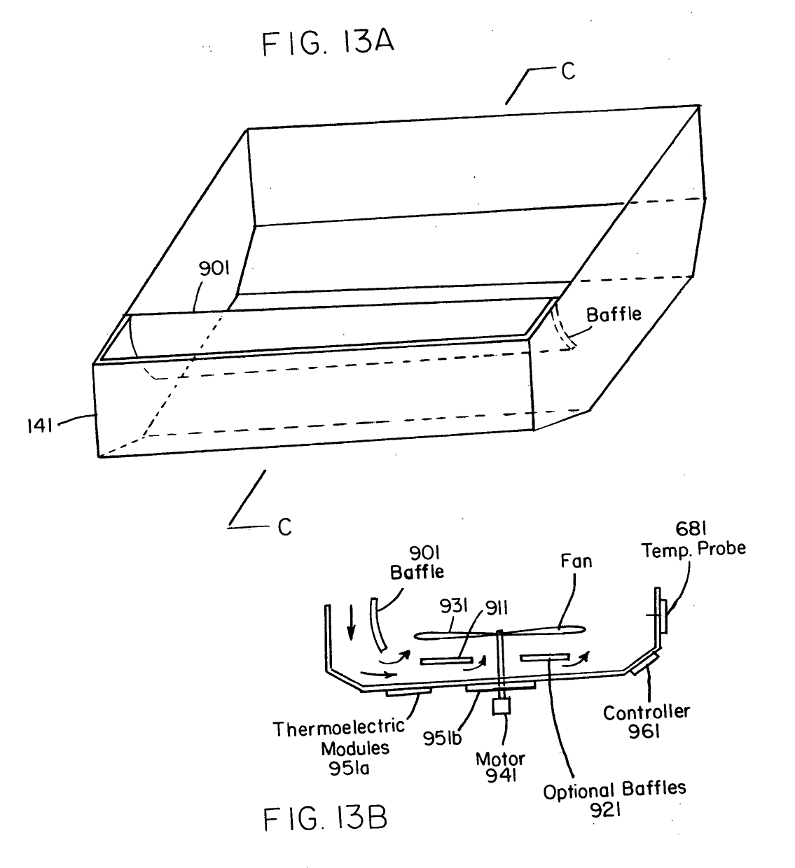

FIGS. 13A and 13B show a lid 14 having a deflecting baffle 901 and a series of channel guides 911 and 921 that help direct heated gases into the cooking region. Fan 931 driven by motor 941 forces the gases through and around the channel guides. Redundant thermoelectric modules 951a and 951b power the motor 941, and controller 961 controls internal temperature of the cooking region. The motor and fan may also be battery-powered and/or include charging by the thermoelectric converter. Because controller 961 does not provide temperature control for the module 951a and 951b, these latter elements are strategically located at a position of the lid 141 to assure their operation within a particular temperature range dictated by thermal properties of the modules, the lid, the heat source of the firebox, etc.

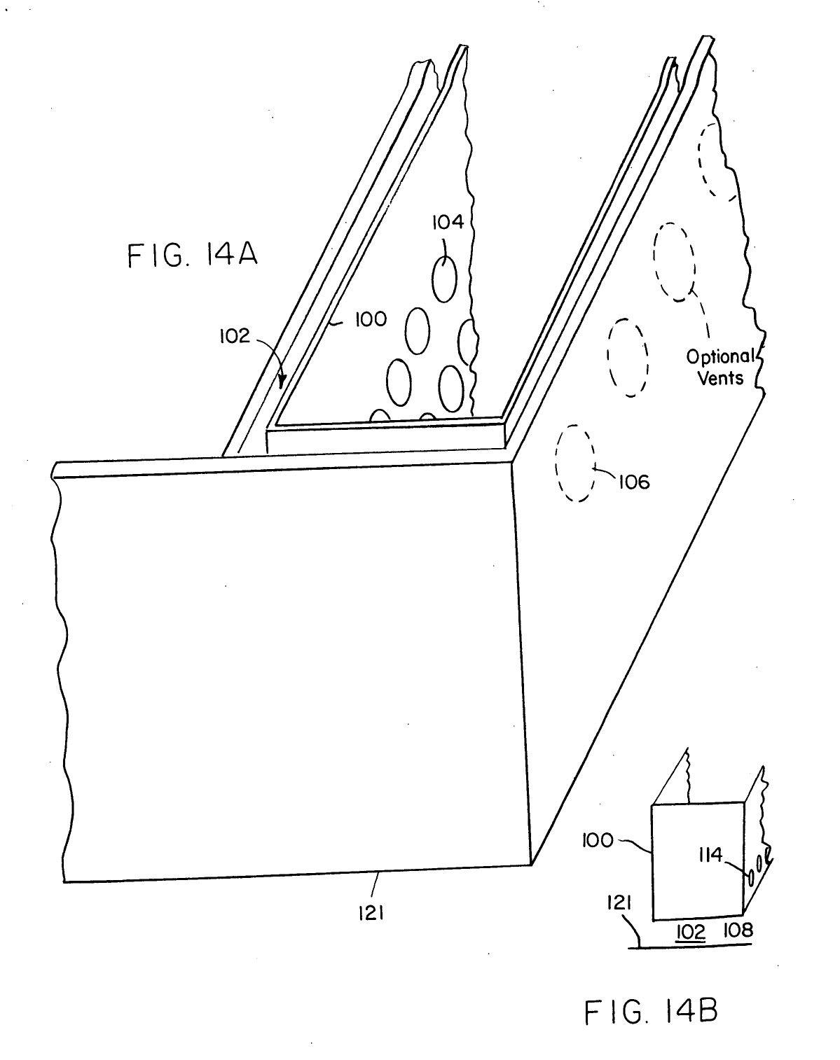

FIG. 14A shows an exemplary charcoal holder 100, e.g., a solid fuel holder that is located in a firebox chamber 102 of base 121. Because charcoal burns at a temperature around 1100 1300 degrees Fahrenheit, the charcoal holder 100 is preferably spaced from the internal walls of the chamber 102 to provide insulation. Holder 100 also includes a series of ventilation holes 104 to facilitate ignition of charcoal. The rear of base 121 may include ventilation ports 106 to facilitate charcoal ignition. Preferably, ports 106, if utilized, are located at a higher level than the holes 104 in order to drive cooler incoming air downward between the walls of base 121 and holder 100.

The arrangement of FIG. 14B achieves cooling more effectively. There, a cooling plate 108 is inserted between the wall of base 121 and the charcoal holder 100. Airflow, indicated by arrow 110 enters the chamber 102 at an upper portion, and proceeds downward through orifice 112, and then through orifice 114 into the charcoal holder 100. Cooling air flowing along such path provide more effective insulation between the charcoal holder 100 and the exterior of the base 121. In actual practice, dual concentric boxes or holders—a first smaller box that holds charcoal and a second larger box that holds the charcoal box at a spaced apart disposition may implement this arrangement.

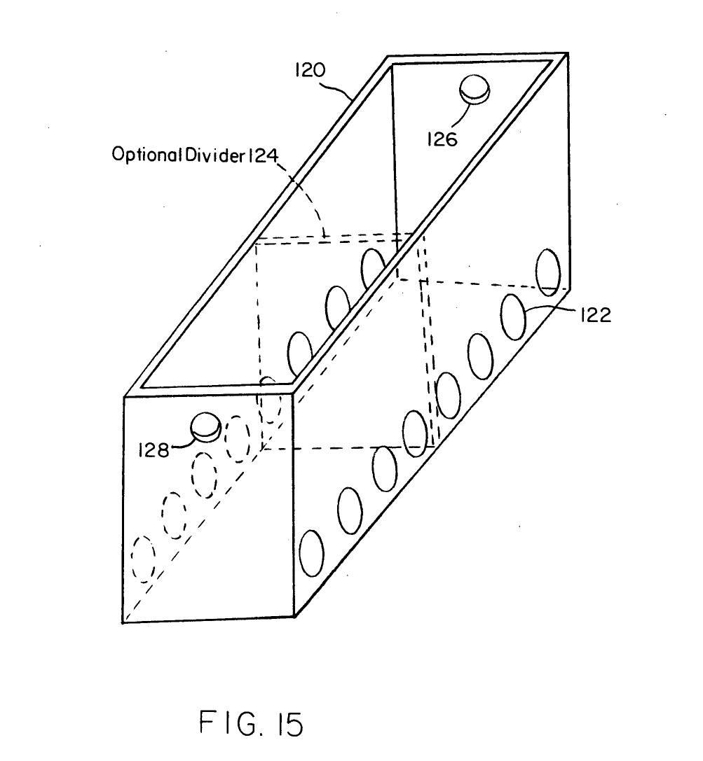

FIG. 15 shows a preferred construction of an enameled steel or stainless charcoal holder 120 that may be used with grill 101. Charcoal holder 120 is essentially a basket having an open upper end and a series of ventilation ports 122 disposed around the lower periphery thereof (only one such port being labeled). When filled with charcoal, ports 122 enable fresh air to reach burning coals disposed in the holder. Holder 120 may also include one or more partitions 124 that divide the holder into smaller segments and to permit vertical stacking of smaller amounts of charcoal. Such smaller amounts of charcoal enable low heat cooking, e.g., slow roasting. The partition advantageously provides vertical stacking of smaller amounts of charcoal for easy ignition and a constant, steady charcoal burn rate. Holes 126, 128 enable grasping of a hot charcoal holder using a grasping handle in order to lift the holder into and away from the firebox of the grill.

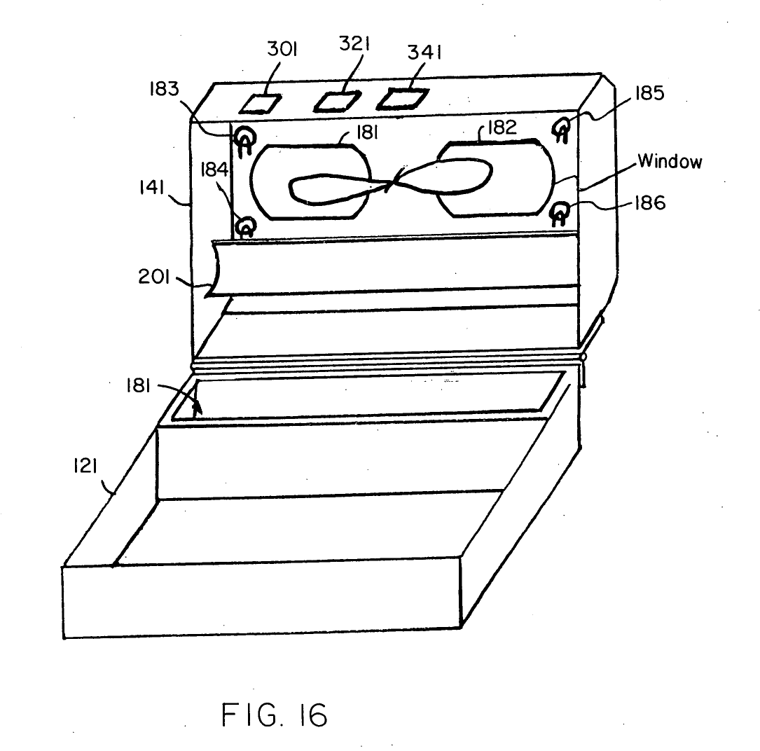

FIG. 16 shows a further improvement including windows 181 and 182 in the lid 141 to enable visual observation of foodstuff while cooking. Also shown are one or more illumination lamps 183, 184, 185, and 186 that are powered by the thermoelectric converter or a battery. This enables a user to see the condition of foodstuff in the cooking region 221 when the lid 141 is closed. When incorporated with a portable grill, non-shattering heat-resistant glass is preferred. A wire rack protector or wire grid/grate overlying the glass panels 181 and 182 may also be desirable.

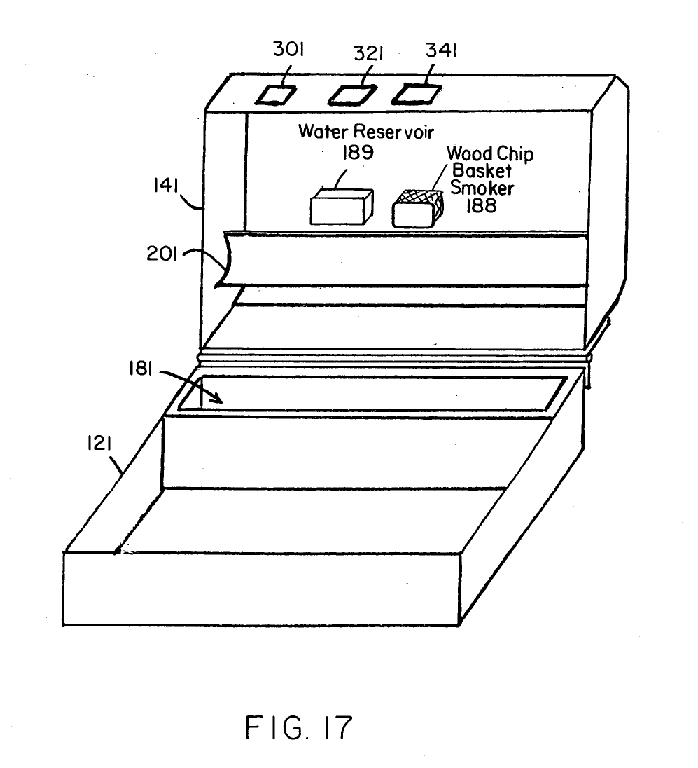

FIG. 17 shows yet further improvements including a smoker basket 188 that holds specialty wood chips near the firebox 181 upon closure of lid 141, as well as a water reservoir 189 to help maintain moisture within the cooking region. Use of hickory and mesquite wood chips in basket 188 adds smoke flavoring. Water in reservoir 189 helps prevent certain foods from drying, and may also provide steam cooking of certain foods and vegetables. Each is placed in the path of heated air upwind of airflow induced by the fans or blowers in order to draw steam and/or smoke into the cooking region. Both the smoker basket 188 and the water reservoir 189 are loaded from the top of the lid, preferably through a trap door.

The embodiments set forth herein are made for purposes of illustration and not to limit the scope of the invention. The invention and aspects thereof may be combined with both horizontal and vertical grills. Neither the heat exchanger nor baffles, channels, and ducts is limited to the embodiments described or disclosed since a variety of heat-exchanging structures may be devised to convey heat from a heated region to a cooking region. A heat transfer material disposed in heat transfer relation with heated gases may include channels or paths from which heat may be extracted and supplied to the cooking region. Such air routing elements or thermal conveyance structure may comprise separate elements or they may be integrally formed with the appliance housing. Fans and blowers may also take on a variety of forms beyond the propeller design shown above. Fans and blower designs include squirrel cage, paddlewheel, and other construction that move or displace air. The location of the thermoelectric converter, temperature sensors, and audio/visual indicators may also vary. Elements positioned in the lid may be relocated to the base. The firebox may be relocated to the front or side of the base, and may even be placed underneath or in a separate holding container separated from the appliance housing where heated gases are routed to the cooking region via ductwork. To provide redundancy and greater reliability, multiple thermoelectric converters, controllers, and sensors may be utilized. The controller may be mechanical or electromechanical, rather than electronic. The size, depth, and capacity of the appliance may also vary. The cooking region may include conventional grids, racks, trays, or even cooking containers. Instead of providing a lid and base, the housing configuration may be altered to any structure, for example, an enclosure having a door. In addition, the processor may comprise a mechanical or electrical controller, or a microprocessor that is powered by line current, battery, or a thermoelectrically generated source deriving energy from the heat source of the grill. The thermoelectric converter may generate power to power an accessory, such as a battery charger, an electronic device (radio, TV, cell phone, computing device, etc.), or any other accessory. Accordingly, it is my intent to include within the scope of my invention all such variations and modifications as may come to a person having skilled in the art.

1. A cooking appliance comprising:
a housing having a base and lid that define a cooking region therebetween,
a gas-fired firebox supported by said housing disposed laterally of said cooking region to produce heated gases,
at least one air channel within said housing in communication with said heated gases and said cooking region,
a source of electrical power, and
a blower powered by the source of electrical power to circulate heated air from said at least one air channel to the cooking region.

2. The cooking appliance of claim 1, wherein said source of electrical power comprises a thermoelectric converter to generate electrical power from said heated gases and said blower is powered by said converter.

3. The cooking appliance of claim 1, wherein said at least one air channel comprises heat transfer ducting in communication with said cooking region to extract heat from heated gases.

4. The cooking appliance of claim 1, wherein said housing comprises a hinged base and a lid to form said housing, said gas-fired firebox being positioned substantially between said base and lid laterally of said cooking region, and said at least one air channel lies within said housing in communication with said firebox.

5. The cooking appliance of claim 1, further including a controller that controls temperature of the cooking region by regulating at least one of gas flow of said gas-fired firebox and air flow in said at least one channel.

6. The cooking appliance of claim 2, further including a controller that controls an operation condition of said thermoelectric converter.

7. The cooking appliance of claim 1, further including an indicator that indicates at least one of elapsed time, internal fire, temperature of said cooking region, thermal efficiency of the converter, power output of converter, hot side and/or cold side temperature difference of said thermoelectric module, efficiency, readiness of cooked foodstuff, output temperature of firebox, motor speed, air flow rate, and BTU output of firebox.

8. A cooking appliance comprising:
a housing that defines a cooking region,
a firebox that generates heat,
a channel that conveys said heat,
a blower to transfer heated air from the channel to the cooking region, and
a thermoelectric converter that derives power from said heat in order to power the blower.

9. The cooking appliance of claim 8, wherein said channel includes heat exchanging ductwork to convey heated air to said cooking region.

10. The cooking appliance of claim 8 further including a controller that controls said blower.

11. The cooking appliance of claim 9, wherein said controller controls an operating temperature of said thermoelectric converter.

12. The cooking appliance of claim 8, further comprising lighting powered by said thermoelectric converter.

13. The cooking appliance of claim 8, wherein said thermoelectric converter provides external power for an accessory device.

14. A method of cooking comprising:
providing a cooking region,
generating heated gases,
extracting heat from said heated gases and supplying said heat to said cooking region,
thermoelectrically converting heat derived from the heated gases into electrical power, and
utilizing said electrical power to supply said heat to the cooking region.

15. The method of claim 14, further including cooling said thermoelectric converter to regulate an operating condition thereof.

16. The method of claim 14, further including powering a microprocessor by said thermoelectric converter in order to control and/or detect an operating condition of said cooking region and/or to provide an indication of said operating condition to a user.

17. The method of claim 14, further comprising utilizing said electrical power to provide illumination.

18. The method of claim 14, further comprising utilizing said electrical power to power and external accessory device.

19. The method of claim 14, further comprising generating said heated gases laterally of said cooking region.
